(19) United States
(12) Patent Application Publication
(10) Pub. No.: US 2013/0219309 A1
(43) Pub. Date: Aug. 22, 2013

(54) TASK PERFORMING METHOD, SYSTEM AND COMPUTER-READABLE RECORDING MEDIUM

(71) Applicant: Samsung Electronics Co. Ltd., (US)

(72) Inventors: Young-shil Jang, Gyeonggi-do (KR); Young-ho Rhee, Gyeonggi-do (KR); Il-ku Chang, Gyeonggi-do (KR); Young-kyu Jin, Seoul (KR)

(73) Assignee: Samsung Electronics Co. Ltd., Gyeonggi-do (KR)

(21) Appl. No.: 13/685,216

(22) Filed: Nov. 26, 2012

(30) Foreign Application Priority Data
Feb. 21, 2012 (KR) 10-2012-0017661

(51) Int. Cl. G06F 3/0482

(52) U.S. Cl. CPC G06F 3/0482; H04L 67/00
USPC 715/764; 345/619; 709/217

(57) ABSTRACT

A task performing method, system, and computer readable recording medium for easily performing a task that corresponds to an event created in a device or in an external device connected to the device are provided. The method includes displaying a user interface screen on the device, the user interface screen including at least one piece of card interface information based on an event created in at least one external device connected to the device or created in the device; and performing a task in the device that corresponds to an input signal based on the displayed user interface screen including the at least one piece of card interface information.

### PRIORITY

This application claims priority under 35 U.S.C. §119(a) to Korean Patent Application No. 10-2012-0017661, filed on Feb. 21, 2012 in the Korean Intellectual Property Office, the entire content of which is incorporated herein by reference.

### BACKGROUND OF THE INVENTION

1. Field of the Invention

The present invention relates generally to performing tasks in a device, and more particularly, to a task performing method, system, and computer-readable recording medium for performing tasks based on an event created in a device.

2. Description of the Related Art

Despite the increasing diversification of functions provided in devices such as smartphones and tablet Personal Computers (PCs), when an event related to each function is created, users are generally required to undergo multiple processing phases of interacting with the device until the user begins performing a desired task based on the event. For example, when an event relating to receiving a text message is created, the user must first view the text message content and then subsequently determine whether to respond to the sender via a call or text message. The user performs a corresponding task according to a decision. Therefore, when the user is not available to provide the necessary input for performing such corresponding tasks (e.g., when the user is driving), the user cannot perform the corresponding task according to the event.

### SUMMARY OF THE INVENTION

An aspect of embodiments of the present invention is to address at least the problems and/or disadvantages and to provide at least the advantages described below. The present invention provides task performing method, system, and computer-readable recording medium for easily performing a task based on an event in a device or in an external device connected to the device.

According to an aspect of the present invention, a method for performing a task in a device is provided. The method includes displaying a user interface screen on the device, the user interface screen including at least one piece of card interface information based on an event created in at least one external device connected to the device or created in the device; and performing a task in the device according to an input signal based on the displayed user interface screen.

According to another aspect of the present invention, a computer-readable recording medium having at least one program embodied thereon including instructions for carrying out a method for performing a method in a device is provided. The method includes displaying a user interface screen on the device, the user interface screen including at least one piece of card interface information based on an event created in at least one external device connected to the device or created in the device; and performing a task in the device that corresponds to an input signal based on the displayed user interface screen including the at least one piece of card interface information.

According to another aspect of the present invention, a device is provided. The device includes a display unit for displaying a user interface screen; a user interface for interfacing with a user; and at least one processor for, in response to an event created in at least one external device connected to the device or created in the device, controlling the display unit to display the user interface screen including at least one piece of card interface information based on an event, and for performing a task in the device corresponding to an input signal received through the user interface based on the displayed user interface screen including the at least one piece of card information.

According to another aspect of the present invention, a server is provided. The server includes a communication unit for receiving information corresponding to an event created in the device or created in at least one external device connected to the device; a storage unit for storing at least one program and at least one piece of card interface information that corresponds to the received information corresponding to the event; at least one processor for reading, from the storage unit, the at least one piece of card interface information that corresponds to the information of at least one event received from the communication unit, and controlling the communication unit to transmit, to the device, the read at least one piece of card interface information that corresponds to the at least one event.

### BRIEF DESCRIPTION OF THE DRAWINGS

The above and other features and advantages of the present invention will become more apparent by describing in detail embodiments thereof with reference to the attached drawings in which:

FIG. 1 is a block diagram illustrating a task performing system, according to an embodiment of the present invention;

FIG. 2 is a detailed block diagram illustrating a device in the task performing system, according to an embodiment of the present invention;

FIGS. 3A to 3F and FIG. 4 are diagrams illustrating examples of user interface screens having at least one piece of card interface information and examples of the card interface information, according to an embodiment of the present invention;

FIG. 5 is a detailed block diagram illustrating an external device according to an embodiment of the present invention;

FIG. 6 is a flowchart illustrating a task performing method of the device, according to an embodiment of the present invention;

FIG. 7 is a flowchart illustrating the task performing method, according to an embodiment of the present invention;

FIG. 8 is a flowchart illustrating the task performing method, according to another embodiment of the present invention;

FIG. 9 is a flowchart illustrating the task performing method, according to another embodiment of the present invention;

FIG. 10 is a block diagram illustrating a server shown in FIG. 1, according to an embodiment of the present invention;

FIG. 11 is a flowchart illustrating a task performing method of the server, according to an embodiment of the present invention; and

FIG. 12 is diagram illustrating a network arrangement according to another embodiment of the present invention.

### DETAILED DESCRIPTION OF EMBODIMENTS OF THE PRESENT INVENTION

Embodiments of the present invention are described as follows with reference to the accompanying drawings. In the following description, detailed descriptions of commonly-used technologies or structures related to the invention may be omitted where such a description unnecessarily obscures the subject matter of the invention. With respect to the drawings and the following description, like reference numerals refer to the same or similar elements.

Although the terms such as “first”, “second”, “third”, etc., may be used herein to describe various elements, these terms are merely used to distinguish elements from each other, and do not otherwise limit these elements.

The terminology used herein is for the purpose of describing particular embodiments only and is not intended to limit the invention. In the following description, the singular forms “a”, “an” and “the” are not necessarily limited to a single element, but may include plural forms as well, unless the context clearly indicates otherwise.

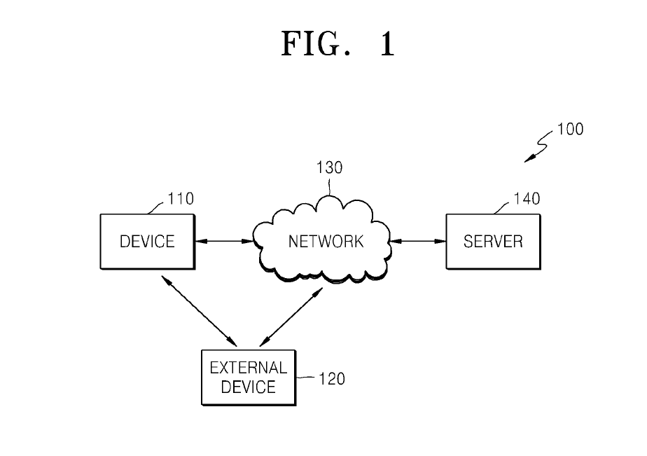

FIG. 1 is a block diagram illustrating a task performing system according to an embodiment of the present invention.

Referring to FIG. 1, the task performing system 100 includes a device 110, an external device 120 connected to the device 110, a network 130 and a server 140. The device 110 has a display function. The device 110 may include any of devices, such as a navigation device used in a vehicle, a telematics (or automotive telematics) device, a head unit, etc.

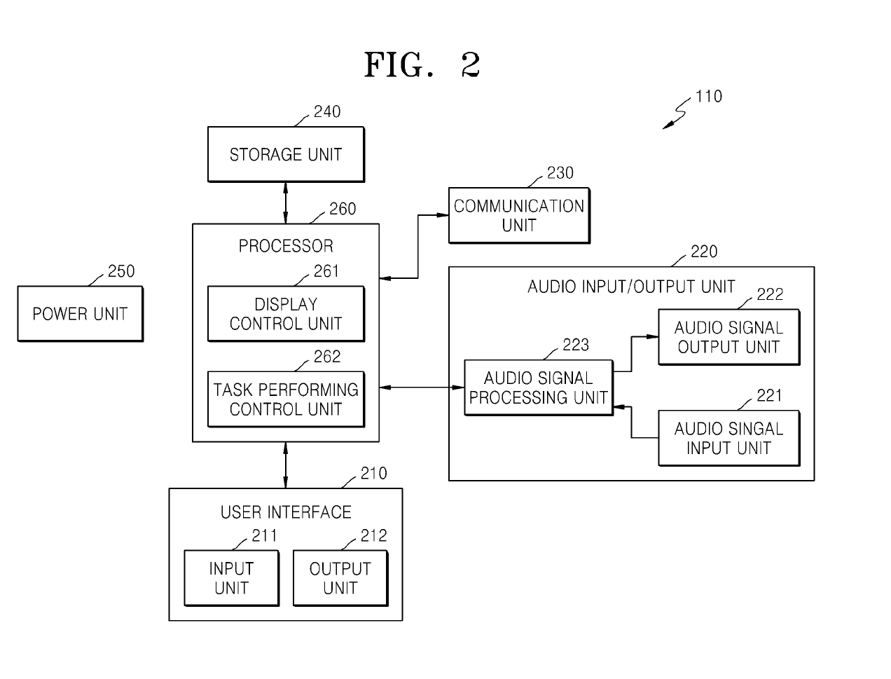

FIG. 2 is a detailed block diagram of a device according to an embodiment of the present invention.

Referring to FIG. 2, the device 110 includes a user interface unit 210, an audio input/output unit 220, a communication unit 230, a storage unit 240, a power unit 250, and a processor 260. The user interface unit 210 provides an interface between a user and the device 110. The user interface unit 210 includes an input unit 211 for inputting an input signal and an output unit 212 for outputting an output signal. The input unit 211 and the output unit 212 may be implemented as separate elements. The user inputs information, commands, and/or instructions through the input unit 211. A signal to be sent or input through the input unit 211 to the processor 260 may be referred to as input information, an input command, or input data.

In one example according to an embodiment of the present invention, the input unit 211 is configured based on a touch interface using a touch panel or a touch screen, and the input unit 211 and the output unit 212 are configured as a combined element. Here, the input unit 211 detects an electric signal obtained by sensing a touch on the touch screen displayed on the output unit 212, converts the electric signal to input data, and sends the input data to the processor 260. In order to receive the touch input, the input unit 211 includes touch sensor(s) (not shown). The electric signal obtained by sensing the touch includes a signal obtained by sensing at least one of touch activity and touch intensity using an external input device (not shown), such as a user's finger or a stylus pen. The touch activity of the external input device may include the number of touches, touch patterns, and touch areas. With a variety of combinations of the touch activity and the touch intensity of the external input device, the input unit 211 provides various input signals to the processor 260.

The input unit 211 may include at least one of physical buttons, switches and control sticks, in addition to, or as an alternative to the touch interface as described above. The external input device based on user's touch activities is not limited to receiving touch input from the user's fingers, and accordingly, the user's touch activities may be or connected to any part of the user's body. The external input device may be referred to as a pointing device.

The input signal input via the input unit 211 according to an embodiment of the present invention includes a selection signal of card interface information, a signal based on drag and drop actions, and a signal based on scroll actions.

The output unit 212 may include displays such as Liquid Crystal Displays (LCDs), Thin Film Transistor-Liquid Crystal Displays (TFT-LCDs), Organic LEDs (OLEDs), flexible displays, 3-Dimensional (3D) displays, Active-Matrix OLEDs (AMOLEDs), etc. Embodiments of the present invention are not limited to these displays, and other such displays may be used in accordance with embodiments of the present invention. The output unit 212 may be a display.

The audio input/output unit 220 provides an audio interface between the user and the device 110. The audio input/output unit 220 includes an audio signal input unit 221, such as a microphone for inputting an audio signal, an audio signal output unit 222, such as a speaker for outputting the audio signal, and an audio signal processing unit 223.

The audio signal input unit 221 converts the input audio signal to an electric signal, which is then transmitted to the audio signal processing unit 223. According to an embodiment of the present invention, the audio signal input unit 221 may include a voice command based on identification information of the card interface information displayed on the output unit 212. The audio signal processing unit 223 converts the electric signal transmitted from the audio signal input unit 221 to audio data, which is then transmitted to the processor 260. The processor 260 may store the audio data received from the audio signal processing unit 223 in the storage unit 240 in the form of a file. The processor 260 may externally output the audio data received from the audio signal processing unit 223 via the communication unit 230, such as through a speaker, for example. The processor 260 may perform tasks according to embodiments of the present invention based on the audio data received from the audio signal processing unit 223. In this case, the audio data may also be referred to as a voice command to perform the task.

The processor 260 transmits audio data read from the storage unit 240 or received via the communication unit 230 to the audio signal processing unit 223. Audio data received via the communication unit 230 may include audio data shared with the external device 120. The audio signal processing unit 223 converts the audio data transmitted from the processor 260 to an electric signal and transmits the electric signal to the audio signal output unit 222. The audio signal output unit 222 converts the received electric signal to a signal that the user is able to hear, and outputs the converted audible signal. The audio signal input unit 221 and the audio signal output unit 222 may be implemented as an integral unit, such as a headset. The audio signal output via the audio signal output unit 222 may be an audio signal reproduced by performing a task according to an embodiment of the present invention. For example, the audio signal output via the audio signal output unit 222 may be an audio signal reproduced by performing a task related to audio or media reproduction.

The communication unit 230 transmits/receives messages and data to/from the external device 120, the server 140, or any other external device (not shown) via a network, such as wired or wireless Internet, a cellular network, a Wireless Area Network (WAN), 3rd generation (3G), 4^{th} Generation (4G), BLUETOOTH®, Radio Frequency IDentification (RFID) and ZIGBEE®. The communication unit 230 may use a plug and play interface, such as a Universal Serial Bus (USB) port (not shown) to transmit/receive the message or the data via a cable with the external device 120. When the device 110 is a display device mounted on a vehicle or a motor vehicle, the communication unit 230 may use the plug and play interface, such as, the USB port, to receive information of an event created in the vehicle. The communication unit 230 may use Wireless Fidelity (Wi-Fi) Direct to connect with the external device 120.

The storage unit 240 may include a non-volatile memory, such as a high-speed random access memory, a magnetic disc storage device and a flash memory, or other non-volatile semiconductor memories. The storage unit 240 stores at least one program and resource required to perform various functions (e.g., communication functions and display functions) of the device 110, including an operating system. Furthermore, the storage unit 240 stores at least one program and resources to perform tasks according to embodiments of the present invention. The resources required to perform the task performing method include at least one piece of card interface information according to an embodiment of the present invention. The card interface information may be stored in the storage unit 240 in the form of a database. When the event corresponds to a Social Network Service (SNS) reception or a Short Message Service (SMS) reception, the message information included in the card interface information is based on information received via the communication unit 230.

The storage unit 240 may have separated storage locations for storing the at least one program required to perform various functions of the device 110 including the operating system and a storage for storing the one or more programs and resources to carry out the task performing method according to the embodiment of the present invention and applications installed in the device 110. The storage unit 240 may also be referred to as a memory herein.

The power unit 250 supplies power to various components of the device 110. The power unit 250 may be also referred to as a power supply herein. The power unit 250 includes one or more power sources, such as a battery or an Alternate Current (AC) source. According to an alternative embodiment of the present invention, the device 110 does not include the power unit 250, but instead includes a connection unit (not shown) that connects to an external power supply (not shown). When the external power supply is included in the vehicle and supplies power through a cigar jack of the vehicle, the connection unit may be configured to be connected to a cable connected to a cigarette lighter jack of the vehicle.

The processor 260 controls all functions of the device 110 and includes one or more processors. When the processor 260 includes multiple processors, each processor may operate separately according to various functions of the device 110.

The processor 260 may be a controller, a microprocessor, a Digital Signal Processor (DSP), etc. The processor 260 operates according to at least one program for performing tasks corresponding to methods according to embodiments of the present invention. The processor 260 may read at least one program for performing such tasks from the storage unit 240 or download the at least one program from an external device, such as an application providing server (not shown) or a market server (not shown), connected through the communication unit 230.

The processor 260 includes a display control unit 261 and a task performing control unit 262, as shown in FIG. 2. The processor 260 may further include an interface unit (not shown) for interfacing between different function modules and the processor 260 in the device 110. However, for convenience, a further description of the interface unit is omitted.

When displaying at least one piece of the card interface information according to an event that occurred in the device 110, the processor 260 may further include a card interface information reader (not shown) for reading the at least one piece of the card interface information from the storage unit 240. The card interface information reader may also be referred to herein as a card interface information selector or a card interface information searcher, because the at least one piece of card interface information is selected or searched for from among a plurality of pieces of the card interface information stored in the storage unit 240. Alternatively, the card interface information reader may also be referred to as a card interface information receiver when the card interface information is obtained by reading the card interface information from the server 140 via the communication unit 230.

The display control unit 261 and the task performing control unit 262 may be implemented as instructions included in the program to perform tasks according to embodiments of the present invention. For example, the display control unit 261 may be implemented as instructions to display the at least one piece of card interface information according to the event that occurred in the device 110. Similarly, the task performing control unit 262 may be implemented as instructions to perform a task in the device that corresponds to an input signal based on a displayed user interface screen, which may correspond to the user interface information described herein. The input signal based on the user interface screen includes a selection signal regarding the plurality of pieces of the card interface information.

The display control unit 261 outputs the at least one piece of card interface information received via the communication unit 130 or read from the storage unit 240, such that the at least one piece of card interface information is contained in the user interface screen output by the output unit 112. The user interface screen may include map information. The display control unit 261 creates the user interface screen such that the map information and the card interface information are independently displayed in separate areas. To display the map information and the card interface information separately, the display control unit 261 may manage the areas in which the map information and the card interface information are displayed, respectively, in a window-splitting manner, or as separate display areas.

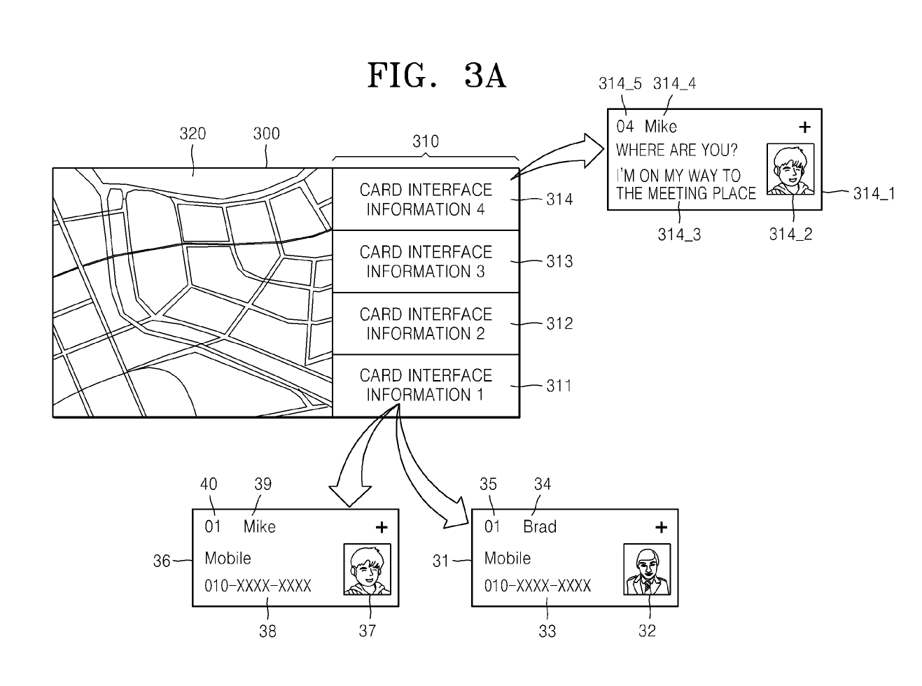

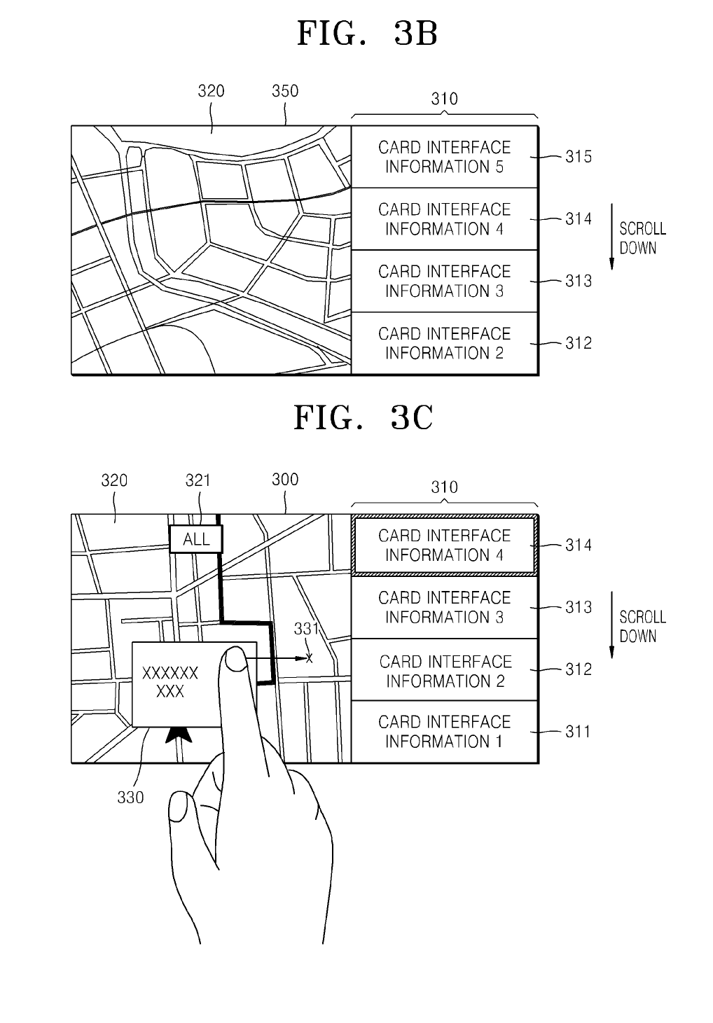

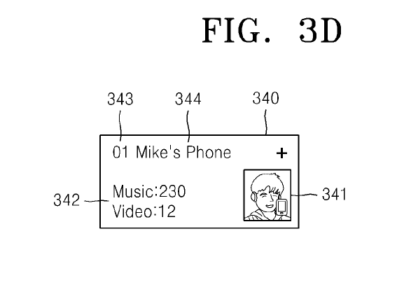

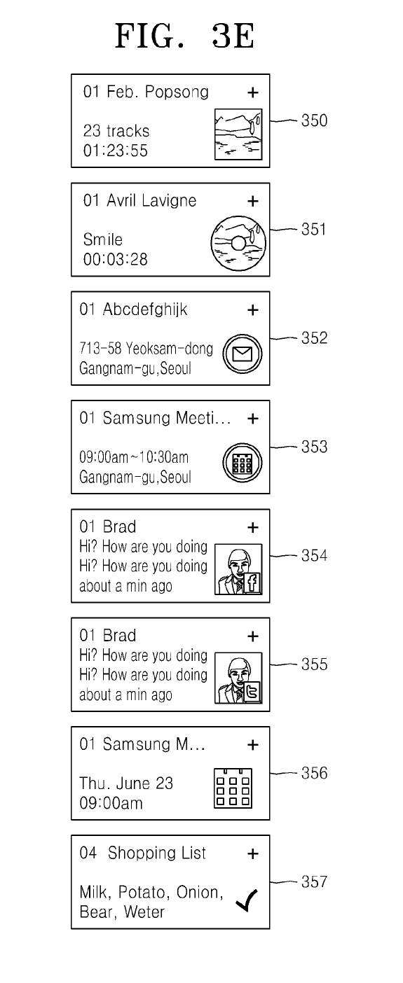

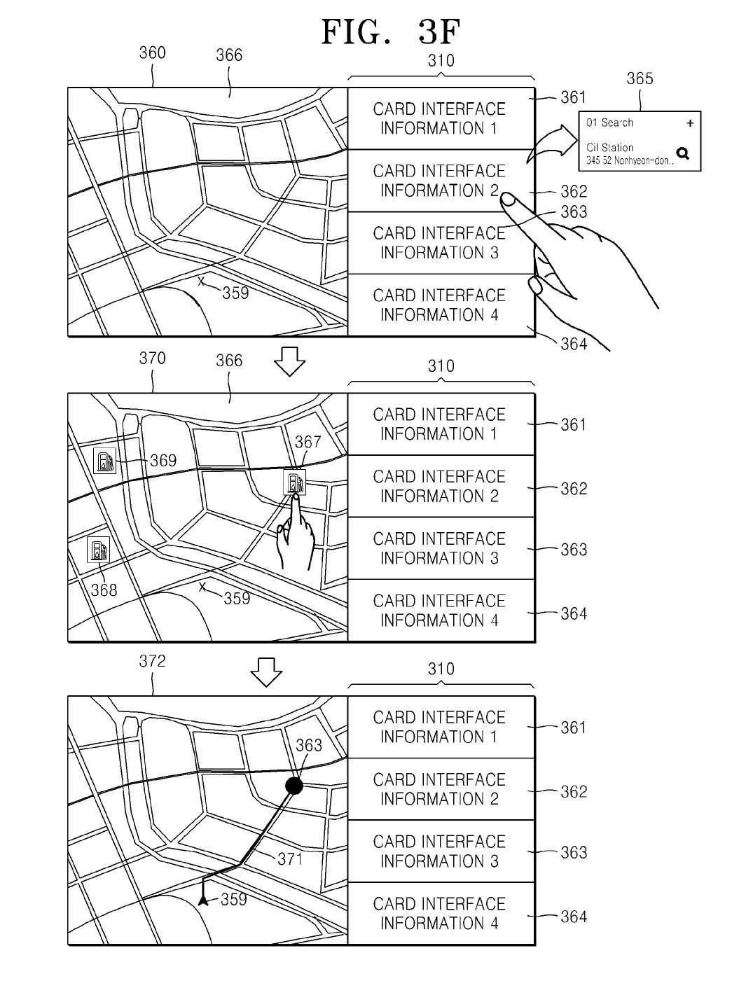

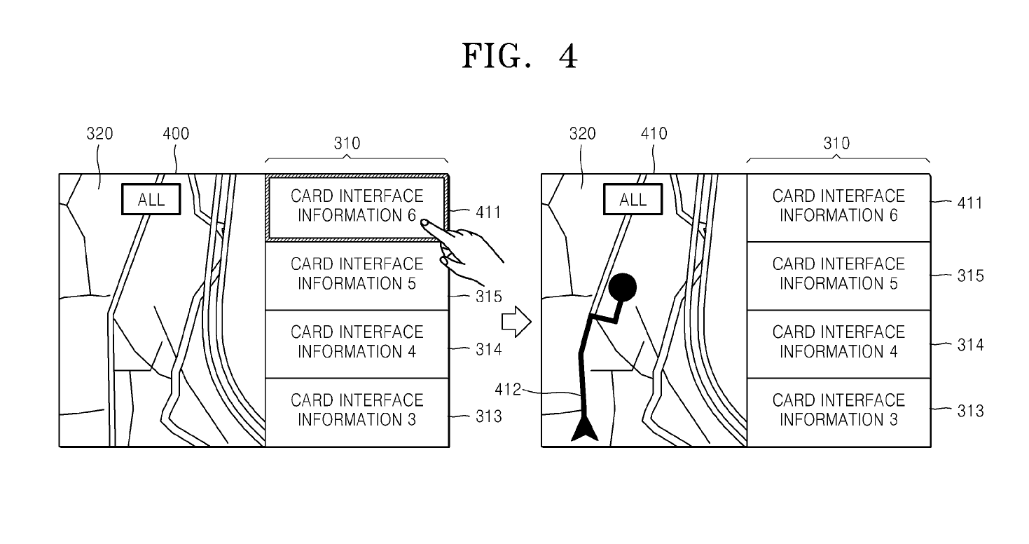

FIGS. 3A to 3F and FIG. 4 are examples of a user interface screen having at least one piece of card interface information and examples of the card interface information, according to an embodiment of the present invention.

FIG. 3A is an example of the user interface screen 300 according to a created event. The user interface screen 300 includes card interface information 1 311 to card interface information 4 314 and the map information 320. The user interface screen 300 displays the card interface information 1 311 to card interface information 4 314 in the right side of the user interface screen 300. However, the card interface information 1 311 to card interface information 4 314 may also be displayed in other areas of the user interface screen 300, such as areas corresponding to the left area, top, or bottom of the user interface screen 300.

The card interface information 1 311 to card interface information 4 314 may be based on different respective events. Events according to embodiments of the present invention include events that occur in the device 110 as well as events that occur in the external device 120 connected to the device 110. For example, when the device 110 having a display function is mounted on a vehicle, an event in the device 110 may correspond to an event that occurred in the vehicle, such as a start event, a fuel or charge request/alarm event, a car accident alarm event, etc. The car accident alarm event includes various events resulting from monitoring whether there was a collision, whether an airbag is working properly, a battery state, etc. The event that occurred in the vehicle is provided by a processor (not shown) installed in the vehicle. The processor installed in the vehicle monitors the state of the vehicle. The start event of the vehicle may be recognized when the power is supplied through the connection unit (not shown) previously described in connection with the power unit 250.

When case the external device 120 is a mobile device, events that occur in the external device 120 include incoming call reception, SMS reception, music reception, schedule information reception, fellow passenger information reception, etc.

The card interface information is user interface information according an event occurred in the device 110 or the external device 120. For example, when the card interface information 1 311 is based on an incoming call reception event, the card interface information 1 311 may include contact card interface information or call keeping card interface information, as shown in card interface information 31 of FIG. 3A. When the card interface information 4 314 is based on an SMS reception event, the card interface information 4 314 may include contact card interface information or SMS keeping card interface information, such as shown in card interface information 314_1 of FIG. 3A.

As shown in card interface information 31 and 314_1, the card interface information 1 311 to card interface information 4 314 may include both image information and text information based on the event that occurred, such as a picture of the face of a sender of a call. The image information 32 contained in the card interface information 31, which corresponds to the card interface information 1 311, may be a picture of the face of an SMS sender. However, the image information that may be contained in the card interface information 1 311 to card interface information 4 314 is not limited to pictures of a face, and may include image information that identifies a task object or image information that represents the task object. The image information that may be contained in the card interface information 1 311 to card interface information 4 314 is set up when the card interface information is created or edited.

The text information included in the card interface information 1 311 to card interface information 4 314 is set up according to events. For example, in card interface information 314_1 the text information includes received text messages 314_3, sender identification information 314_4, and identification information 04 314_5 of the card interface information. In the card interface information 31, the text information includes a phone number 33, sender identification information 314 indicating the name “Brad”, and the identification information 35 “01” of the card interface information. When the user touches or clicks on the card interface information 31, the task performing control unit 262 of the processor 260 calls Brad.

The user may select one of the card interface information 1 311 to card interface information 4 314 through a voice command with respect to identification information ‘1’ or ‘2’. In other words, as shown in user interface screen 300 of FIG. 3A, when a user interface screen is displayed on the output unit 212 and the voice command ‘1’ is input through the input unit 221, the voice command is transmitted to the processor 260 through the audio signal processing unit 223. Then, the processor 260 recognizes that the card interface information 1 311 has been selected and allows the task performing control unit 262 to perform the task to call Brad.

Further, when the card interface information 1 311 to card information 4 314 are based on different respective events, and when new card interface information 5 315 is created, the user interface screen 300 of FIG. 3A is changed to another user interface screen, such as user interface screen 350 of FIG. 3B. In other words, in the user interface screen 300 of FIG. 3A, where the card interface information 4 314 is the most recently created card user interface information and the card interface information 1 311 is the oldest card user interface information, when the new card interface information 5 315 is created, the oldest card interface information 1 311 disappears from the user interface screen 300 by a shift operation. The card interface information 1 311 may appear back in the screen 310 when the user scrolls the card interface information by touching the screen 310. Positions of the oldest card interface information and the newest card interface information are not limited to the above-described example. For example, card interface information 1 311 and card interface information 4 314 may be the newest and oldest card interface information, respectively.

The card interface information 1 311 to card interface information 314 may be based on multiple tasks according to an event. For example, when the card interface information 1 311 to card interface information 314 are based on events of receiving SMSs from external devices such as the external device 120, the card interface information 1 311 may not include Brad's phone number 33 but include, for example, Mike's mobile phone number 36.

In addition, when an event is created based upon powering-on of the device 110, the card interface information 1 311 to card interface 314 may include information for allowing the user to communicate with a participant included in a user's schedule information in as soon as possible the power-on is commenced. The information includes a phone number, an email address, etc. When the device 110 is mounted in the vehicle, the device 110 powers on when the vehicle starts. When the event is created based on the power-on of the device 110, the card interface information 1 to card interface information 4 314 may be created based on a function frequently used by the user or by a person whom the user often contacts. The person may include the user's friends.

FIG. 3C is an example of a screen in which a task is performed based on the displayed card interface information, according to the SMS reception event from the external device 120. When the user touches or clicks on the card interface information 4 314, which is received or read in response to receiving the SMS, a pop-up window 330 is displayed in an area, which is an area other than the area 310 in which the card interface information is displayed. The pop-up window 330 contains the received SMS content. The content to be displayed in the pop-up window 330 may include only the SMS text message 314_3 contained in the card interface information 314_1 of FIG. 3A. The same content as the card interface information 314_1 may be displayed in the pop-up window 330.

When the user performs a long press on the displayed pop-up window 330 and drag-and-drops the pop-up window 330 on a desired location 331, the processor 260 performs a task to send a message containing information about the location 331 to the SMS sender. When an area 321 including the word ‘ALL’ is touched or clicked, all of the card interface information is displayed.

FIG. 3D is an example of the card interface information 340 according to an event of media information sharing acceptance. When the external device 120 is mounted in the vehicle, the external device 120 may be a mobile device of a passenger in the vehicle, or a driver's mobile device. When media information sharing is accepted on the mobile device of the passenger or the driver, card interface information such as the card interface information 340 as shown in FIG. 3D may be displayed in screen 310 corresponding to the card interface information, as shown in FIGS. 3A to 3C. When a friend registered in an address book stored in the storage unit 240 of the device 110 is the passenger, the card interface information 340 shown in FIG. 3D, which is used for media information sharing, is displayed on the user interface screen when the external device 120, which is the friend's mobile device, connects to the device 110. When the card interface information 340 shown in FIG. 3D is selected through the user interface screen, the processor 260 of the device 110 accepts sharing of media information stored in the external device 120, which corresponds to the friend's mobile device in the present example. When the passenger exits the vehicle, the card interface information for the media information sharing disappears from the user interface screen.

FIG. 3E shows examples of various card interface information is created according to various events. Card interface information 350 includes a playlist and/or information about a music album for sharing the music between the external device 120 and the device 110, when an event based on the selection of the music on the external device 120 occurs. Card interface information 351 includes music card information for sharing the music between the external device 120 and the device 110 when the event based on the selection of the music on the external device 120 occurs. When the card interface information 350 or 351 is selected on the user interface screen, the processor 260 of the device 110 plays the corresponding music.

Card interface information 352 of FIG. 3E including Point Of Interest (POI), information when an event based on the SMS reception of the external device 120 occurs. When the card interface information 352 is selected on the user interface screen, the processor 260 of the device 110 moves map information displayed in the map information area 320 to a corresponding location.

Card interface information 353 of FIG. 3E, which includes the POI information based on the user's schedule information stored in the storage unit 240, is displayed when the vehicle starts. When the card interface information 353 is selected on the user interface screen, the processor 260 of the device 110 performs moves map information displayed in the map information area 320 to a corresponding location.

Card interface information 354 and 355 of FIG. 3E includes contents updated in real time according to an SNS update event of the external device 120. When the card interface information 354 or 355 is selected on the user interface screen, the processor 260 of the device 110 displays a corresponding feed in the form of a pop-up. Displayed Information contained in the card interface information 354 and 355 may scroll in real time due to real-time updates, independent of a user's selection activities.

Card interface information 356 of FIG. 3E includes a next scheduled item according to a current time event. When the card interface information 356 is selected on the user interface screen, the processor 260 of the device 110 controls display of a detailed information screen for the scheduled item in an area other than the screen 310 for displaying the card interface information. For example, the detail information screen of the scheduled item may be displayed in a pop-up window.

Card interface information 357 of FIG. 3E includes to-do items according to a final scheduled destination setting event. When the card interface information 357 is selected on the user interface screen, the processor 260 of the device 110 controls display of detailed information of the to-do item in an area other than the screen 310 for the displayed card interface information.

FIG. 3F shows screens on which a user interface screen 360 including card interface information 2 362 according to a fuel alarm event is displayed. The card interface information 2 362 includes the same information as shown in card interface information 365. When the user touches or clicks on the card interface information 2 362, the user interface screen 360 is changed to a user interface screen 370 on which icons 367, 368, and 369 indicating gas stations are displayed in a map information area 366. When the user selects icon 367, the processor 260 changes the user interface screen 370 to a user interface screen 372 that includes route guide information 371 that shows a route from a current location 359 to a location corresponding to the icon 367.

FIG. 4 illustrates user interface screens 400 and 410 having new card interface information 6 411 in response to the occurrence of an SNS update event. The card interface information 6 411 includes location information about a meeting. When the user clicks or touches the user card interface information 6 411, the processor 260 changes a map information area 320 from a user interface screen 400 to a user interface screen 410 to include location guide information 412.

The task performing control unit 262 controls the tasks to be performed in the same manner as described in connection with FIGS. 3A to 3F, in response to input signals based on a user's touch or click on the displayed card interface information as shown in FIGS. 3A to 3F and FIG. 4. The tasks include at least one of making a call, sending a message, sharing media, playing the media, setting a destination, viewing SNS content, viewing detailed schedule information, viewing detailed to-do lists, indicating neighboring POI information, etc.

The external device 120 of FIG. 1 is a device that connects via wires or wirelessly, and may be any device such as smart phones, smart TeleVisions (TVs), Personal Computers (PCs), desktop PCs, notebook PCs, tabletops, smart boards, tablet PCs, digital photo frames, mobile devices, handheld devices or handheld computers, media players, Personal Digital Assistants (PDAs), etc.

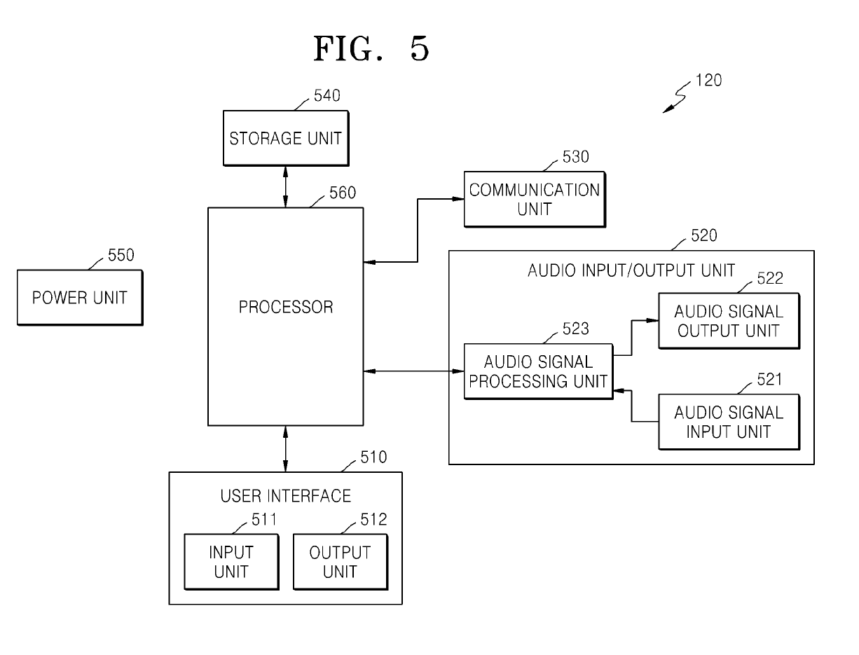

When an event occurs, the external device 120 transmits the event to the server 140 or the device 110 over the network 130. FIG. 5 illustrates an example of a configuration of the external device 120 according to an embodiment of the present invention.

Referring to FIG. 5, the external device 120 includes a user interface unit 510, an audio input/output unit 520, a communication unit 530, a storage unit 540, a power unit 550, and a processor 560. The user interface 510 includes an input unit 511 and an output unit 512. The audio input/output unit 520 includes an audio signal processing unit 523, an audio signal input unit 521, and an audio signal output unit 522. The operations of these components are similar to the operations described herein with respect to corresponding components of FIG. 2.

In addition to the operations described with respect to FIG. 2, when an event occurs in the external device 120, the programs to execute the task performing method may be transmitted from the external device 120 to the device 110 or to the server 140 over the network 130. Referring back to FIG. 5, the processor 560 connects the device 110 to the external device 120 via the communication unit 530, and informs the device 110 or the server 140 via the communication unit 530 that an event has occurred when the processor 560 recognizes the event preset as described above has occurred in the external device 120.

Referring to FIG. 1, the network 130 may be a wireless network as described herein with reference to the communication unit 230 of FIG. 2 and the communication unit 530 of FIG. 5.

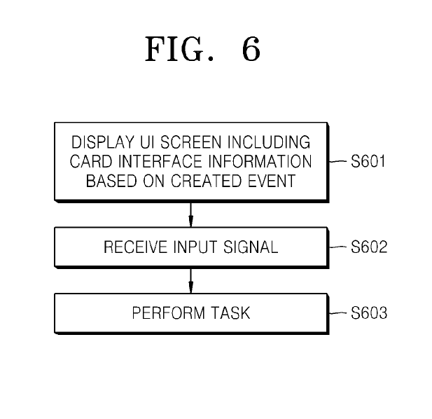

The processor 260 of FIG. 2 operates according to an operational flow of task performing methods according to embodiments of the present invention, as shown in FIG. 6.

Referring to FIG. 6, in step S601, the processor 260 displays the user interface screen at the output unit 212, the user interface screen including at least one piece of card interface information according to an event that occurred in the device 110 or the external device 120 connected to the device 110. The card interface information to be displayed at the output unit 212 is the same as described herein with reference to FIGS. 3A to 3F and FIG. 4.

Upon receiving the user's input signal based on the user interface screen displayed at the output unit 212, the processor 260 performs a task in response to the received input signal as described herein with reference to FIGS. 3A to 3F and FIG. 4, in step S603.

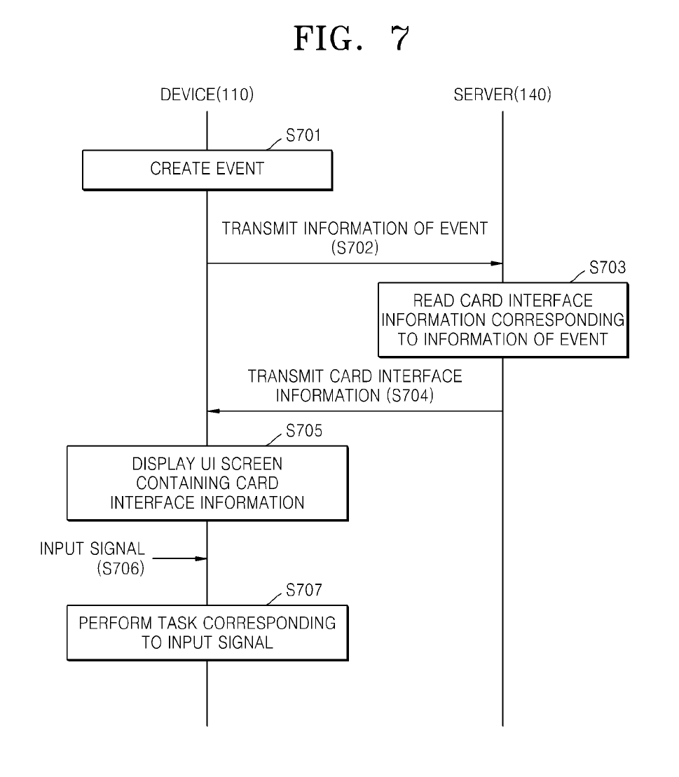

FIG. 7 is a flowchart illustrating an example of providing the card interface information in a server in response to an event that occurred in a device, in according to an embodiment of the present invention.

Referring to FIG. 7, when an event occurs in the device 110, the device 110 transmits information of the event to the server 140, in step S702. The server 140 then reads card interface information from a database (not shown) that corresponds to the received information of the event and sends the card interface information to the device 110, in step S703. Accordingly, the output unit 212 of the device 110 displays user interface information including the received card interface information, as shown in FIGS. 3A to 3F and FIG. 4, in step S705. When an input signal based on the user's click or touch activities based on the displayed user interface information in step S706 is received, the device 110 performs the corresponding task in step S707.

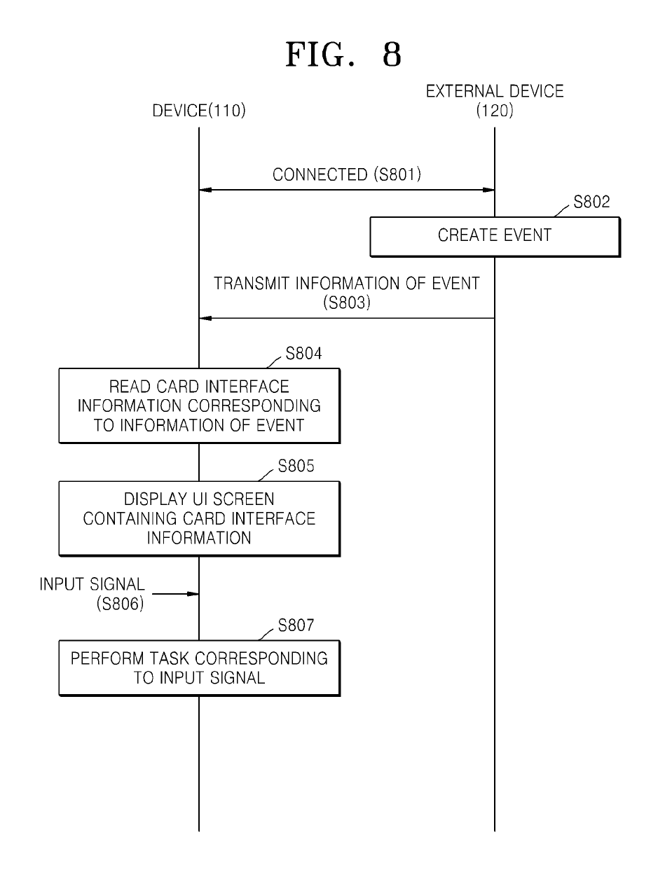

FIG. 8 is a flowchart illustrating an example of a method of creating a card interface information highlight in response to the event that occurred in an external device, according to an embodiment of the present invention.

After the device 110 is connected to the external device 120 in step S801, when an event occurs in the external device 120 in step S802, the external device 120 transmits information of the created event to the device 110 in step S803. The device 110 then reads at least one piece of card interface information that corresponds to the received event from the storage unit 240 in step S804. The output unit 212 of the device 110 displays the user interface information that contains the read card interface information in the manner shown in FIGS. 3A to 3F and FIG. 4, in step S805. When an input signal resulting from certain user activities, such as clicking on or touching the displayed user interface information in step S806, the device 110 performs the task that corresponds to the input signal in the manner described herein with respect to FIGS. 3A to 3F and FIG. 4, in step S807.

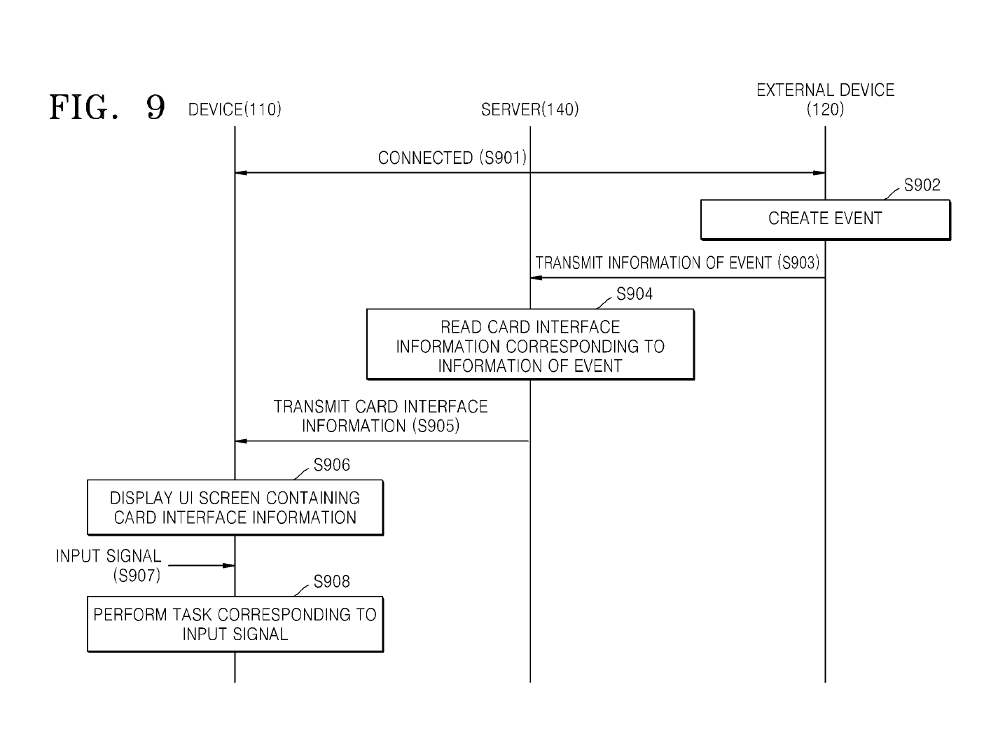

FIG. 9 is a flowchart illustrating a method of providing a card interface information in a server in response to an event that occurred in an external device according to an embodiment of the present invention.

Referring to FIG. 9, after the device 110 is connected to the external device 120 in step S901 and an event subsequently occurs in the external device 120 in step S902, the external device 120 transmits information of the created event to the server 140 in step S903. The server 140 then reads at least one piece of card interface information from the database of the card interface information in step S904. The server 140 transmits the read card interface information to the device 110 in step S905. Accordingly, the output unit 212 of the device 110 displays user interface information including the received card interface information in the manner shown in FIGS. 3A to 3F and FIG. 4, in step S906. When the input signal resulting from user activities, such as clicking on or touching the displayed user interface information in step S907, is received, the device 110 performs a task corresponding to the input signal in the manner described herein with respect to FIGS. 3A to 3F and FIG. 4, in step S908.

FIG. 10 is a detailed block diagram of the server shown in FIG. 1 according to an embodiment of the present invention.

Referring to FIG. 10, the server 140 includes a storage unit 1001, a communication unit 1002, and a processor 1003. The storage unit 1001 stores programs and at least one piece of card interface information corresponding to at least one event. The at least one piece of card interface information may include information collected based on an SNS. The card interface information may be stored in the storage unit 240 in the form of a database for the card interface information. Alternatively, the server 140 may be configured to use the card interface information stored in an external storage device (not shown).

The communication unit 1002, which is configured in a manner similar to the configuration of the communication unit 230 of FIG. 2, transmits/receives data to/from the device 110 and the external device 120 and may transmit/receive information from/to a connected SNS server (not shown).

The processor 1003 may perform a method according to an embodiment of the present invention by loading a program for performing the method from the storage unit 1001 or downloading the program from a connected application providing server or market server over the network 130.

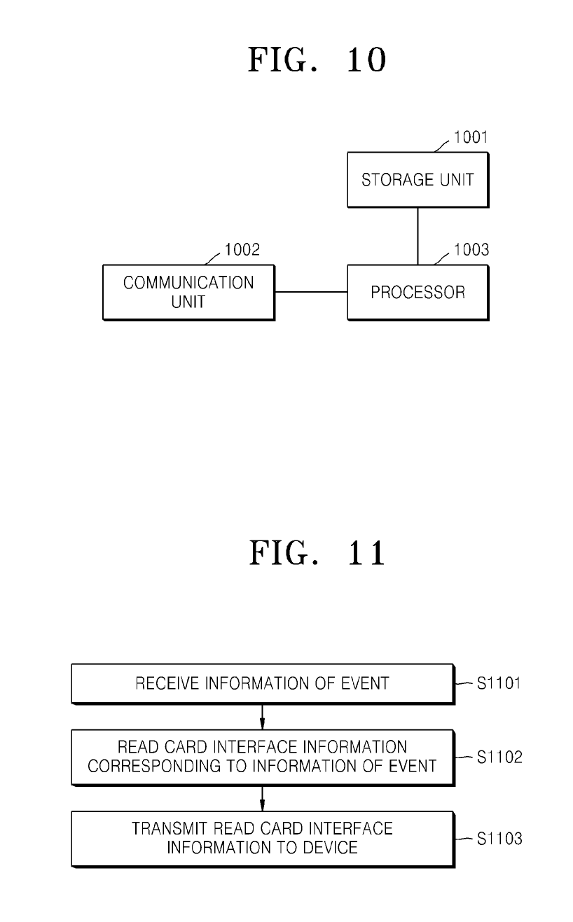

FIG. 11 is a flowchart illustrating an operation of a processor according to an embodiment of the present invention.

Referring to FIG. 11, upon receiving the event information via the communication unit 1002, the processor 1003 reads at least one piece of card interface information stored in the storage unit 1001 or the card interface information database in step S1102, where the at least one piece of card interface information corresponds to the received event. According to an alternative embodiment of the present invention, the read operation of step S1102 may be replaced by a selection or a searching operation as described in connection with FIG. 2. The processor 1003 transmits the read at least one piece of card interface information to the device 110 through the communication unit 1002 in step S1103. In order to receive the card interface information, the processor 1003 may identify the device 110 based on identification information of a target device contained in the received event information. The target device is a device that will receive the card interface information. The identification information of a target device contained in the received event information may include identification information corresponding to a plurality of devices. When the identification information of a target device includes the identification information corresponding to a plurality of devices (not shown) including the device 110, the processor 1003 transmits the read card interface information to the plurality of devices including the device 110. Here, the plurality of devices may be devices having functions to display the card interface information and to use the displayed information in the same manner as performed by the device 110.

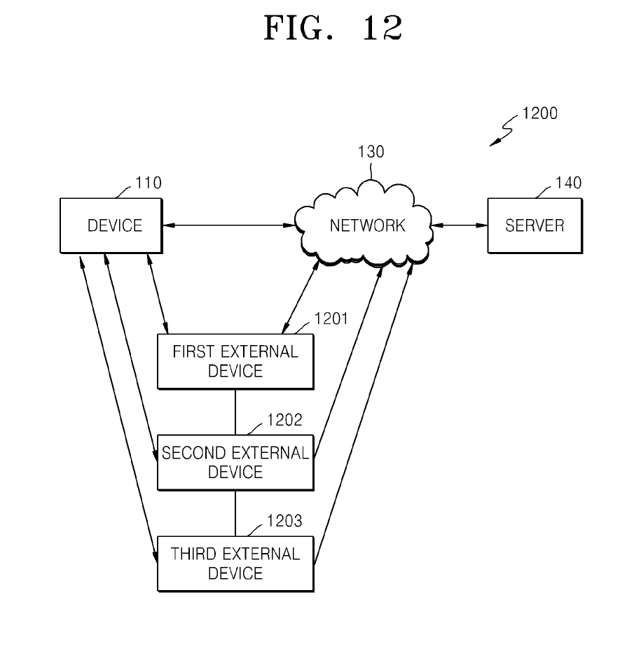

FIG. 12 illustrates an example of a network arrangement for performing a method according to an embodiment of the present invention.

Referring to FIG. 12, a network 1200 connects the device 110 shown in FIG. 1 to first, second, and third external devices 1201, 1202, and 1203, respectively. The device 110 performs a task corresponding to the input signal based on the at least one piece of card interface information corresponding to events created by the first, second, and third external devices 1201, 1202, and 1203. The first, second, and third devices 1201, 1202, and 1202 may all be mobile devices. Alternatively, first external device 1201 may be a mobile device while the second and the third external devices 1202 and 1203 are other user devices or different types of mobile devices. For example, the first and third external devices 1201 and 1203 may be smart phones of different users and the second external device 1202 may be a tablet PC.

Programs having instructions, when executed by a computer, for carrying out the task performing method according to embodiments of the present invention may be recorded on a computer-readable recording medium as computer-readable codes. Such a computer-readable recording medium may be any data storage device that can store programs or data that can be thereafter read by a computer system. Examples of computer-readable recording mediums include Read-Only Memory (ROM), Random-Access Memory (RAM), Compact Disc (CD)-ROMs, magnetic tapes, floppy disks, optical data storage devices, etc. Computer-readable recording mediums according to embodiments of the present invention can also be distributed over network-coupled computer systems so that the computer-readable codes are stored and executed in a distributed fashion.

While the present invention has been particularly shown and described with reference to certain embodiments thereof, it will be understood by those of ordinary skill in the art that various changes in form and details may be made therein without departing from the spirit and scope of the present invention as defined by the following claims.

What is claimed is:

1. A method for performing a task in a device, the method comprising:
displaying a user interface screen on the device, the user interface screen including at least one piece of card interface information based on an event created in at least one external device connected to the device or created in the device; and
performing a task in the device according to an input signal based on the displayed user interface screen including the at least one piece of card interface information

2. The task performing method of claim 1, wherein the at least one piece of card interface information includes at least one of image information and text information that are related to the event.

3. The task performing method of claim 1, wherein displaying the user interface screen on the device comprises:
transmitting information corresponding to the event from the device to a server;
receiving the at least one piece of card interface information from the server in response to the transmission of the information corresponding to the event; and
displaying, on the device, the user interface screen including the received at least one piece of card interface information.

4. The task performing method of claim 1, wherein displaying the user interface screen on the device comprises:
receiving the at least one piece of card interface information from a server; and
displaying, on the device, the user interface screen including the received at least one piece of card interface information.

5. The task performing method of claim 1, wherein the user interface screen further includes map information displayed separately from the at least one piece of card interface information.

6. The task performing method of claim 1, wherein the task includes at least one of making a call, sending a message, sharing media, playing the media, setting a destination, viewing Social Network Service (SNS) content, viewing detailed schedule information, viewing detailed to-do lists, and indicating neighboring Point Of Interest (POI) information.

7. The task performing method of claim 1, wherein the device is mounted on a vehicle and display the user interface screen through an in-car display device, and wherein the external device is a mobile device connected to the device.

8. The task performing method of claim 1, wherein the task is performed according to a voice command based on identification information of the at least one piece of card interface information.

9. A computer-readable recording medium having at least one program embodied thereon including instructions for carrying out a method for performing a task in a device, the method comprising:
displaying a user interface screen on the device, the user interface screen including at least one piece of card interface information based on an event created in at least one external device connected to the device or created in the device; and
performing a task in the device that corresponds to an input signal based on the displayed user interface screen including the at least one piece of card interface information.

10. A device comprising:
a display unit for displaying a user interface screen;
a user interface for interfacing with a user; and
at least one processor for, in response to an event created in at least one external device connected to the device or created in the device, controlling the display unit to display the user interface screen including at least one piece of card interface information based on an event, and for performing a task in the device corresponding to an input signal received through the user interface based on the displayed user interface screen including the at least one piece of card information.

11. The apparatus of claim 10, wherein the at least one piece of card interface information includes at least one of image information and text information which are related to the event.

12. The apparatus of claim 10, wherein controlling the display unit to display the user interface screen including the at least one piece of information includes transmitting information corresponding to the event from the device to a server, receiving the at least one piece of card interface information from the server in response to the transmission of the information corresponding to the event, controlling the display unit to display the user interface screen including the received at least one piece of card interface information.

13. The apparatus of claim 10, wherein controlling the display unit to display the user interface screen including the at least one piece of information includes receiving the at least one piece of card interface information from a server, and controlling the display unit to display the user interface screen including the received at least one piece of card interface information.

14. The apparatus of claim 10, wherein the user interface screen further includes map information displayed separately from the at least one piece of card interface information.

15. The apparatus of claim 10, wherein the task includes at least one of making a call, sending a message, sharing media, playing the media, setting a destination, viewing Social Network Service (SNS) content, viewing detailed schedule information, viewing detailed to-do lists, and indicating neighboring Point Of Interest (POI) information.

16. The apparatus of claim 10, wherein the device is mounted on a vehicle and display the user interface screen through an in-car display device, and wherein the external device is a mobile device connected to the device.

17. A server comprising,
a communication unit for receiving information corresponding to an event created in the device or created in at least one external device connected to the device;
a storage unit for storing at least one program and at least one piece of card interface information that corresponds to the received information corresponding to the event;
at least one processor for reading, from the storage unit, the at least one piece of card interface information that corresponds to the information of at least one event received from the communication unit,
and controlling the communication unit to transmit, to the device, the read at least one piece of card interface information that corresponds to the at least one event.

18. The server of claim 17, wherein transmitting the read at least one piece of card interface information to the device includes transmitting the at least one piece of card interface information to the device based on identification information of a target device to receive the at least one piece of card interface information, the identification information of the target device being contained in the received information of the at least one event.
